(19) United States
(12) Patent Application Publication
(10) Pub. No.: US 2018/0279683 A1
(43) Pub. Date: Oct. 4, 2018

(54) ATOMOIZER AND ELECTRONIC CIGARETTE HAVING THE SAME

(71) Applicant: Changzhou Patent Electronic Technology Co., Ltd., Changzhou (CN)

(72) Inventor: Weihua QIU, Changzhou (CN)

(21) Appl. No.: 15/937,012

(22) Filed: Mar. 27, 2018

(30) Foreign Application Priority Data
Mar. 28, 2017 (CN) 201720315167.6
Mar. 28, 2017 (CN) 201720315169.5

(51) Int. Cl. A24F 47/00; H05B 3/44

(52) U.S. Cl. CPC A24F 47/008; H05B 3/44

(57) ABSTRACT

An electronic cigarette has an atomizer. The atomizer includes a ventilation pipe; a connecting pipe sleeved on the ventilation pipe; a sleeving tube; an atomizing head, and an upper cover assembly positioned in the sleeving tube. Wherein the atomizing head is connected to the ventilation pipe and the connecting pipe, the atomizing head defining an atomizing chamber therein. The upper cover assembly is positioned on a top of the sleeving tube.

### FIELD OF THE INVENTION

The disclosure relates to a technical field of smoking simulating, and more particularly, relates to an atomizer and a cigarette having the atomizer, the atomizer has two air intake modes.

### BACKGROUND

An electronic cigarette is used to help and assist smoker to perform a smoking cessation or used to enjoy stimulation of essence applied to the olfactory system. The atomizer is an essential component of the electronic cigarette. At present, the atomizers in the market all adopt a single air intake regulating structure, in such singular upper air intake mode or in such singular lower air intake mode, the position of the air intake cannot be adjusted to change an atomization effect or a flavor, thus the requirements of different users cannot be met.

### SUMMARY

Accordingly, it is necessary to provide an atomizer, which can change the air intake mode so as to change an atomization effect or a flavor, thus meeting the requirements of different users.

The technical solution adopted by the disclosure to solve the problem is:

An atomizer, includes: a ventilation pipe; a connecting pipe sleeved on the ventilation pipe; a sleeving tube; an atomizing head positioned in the sleeving tube, and an upper cover assembly. The atomizing head is connected to the ventilation pipe and the connecting pipe, the atomizing head defines an atomizing chamber therein. The upper cover assembly is positioned on a top of the sleeving tube, the upper cover assembly includes a first connecting member, and a second connecting member. At least a part of the second connecting member is laminated upon the first connecting member, the first connecting member defines a first air intake, the second connecting member defines a first ventilation hole fluidly communicating with the first air intake. A communication area between the first air intake and the first ventilation hole can be adjusted; and a base seat assembly including a lower cover and a second regulating ring, the lower cover being connected to the lower end of the atomizing head, the second regulating ring being rotatably sleeved on a circumference of the lower cover. Wherein the second regulating ring defines a second air intake, the lower cover defines a second ventilation hole, when the second regulating ring is rotated, the communication area between the second air intake and the second ventilation hole is adjusted. The second ventilation hole fluidly communicates with the atomizing chamber; a separation between the connecting pipe and the ventilation pipe constitutes a first intake passage communicating the first ventilation hole with the atomizing chamber.

According to one embodiment, wherein the first connecting member is a mouth piece, the mouth piece is integrally provided with a first regulating ring on a lower end thereof, the first air intake is defined on the first regulating ring, the second connecting member is an upper cover.

According to one embodiment, wherein an upper end of the ventilation pipe extends into the mouth piece, and is rotatably connected to the mouth piece.

According to one embodiment, wherein the atomizing head includes an atomizing outer pipe, a heater, and an absorbing member, the heater and an absorbing member are received in the atomizing outer pipe, an inner space of the atomizing outer pipe constitutes the atomizing chamber.

According to one embodiment, wherein the atomizing head further includes a supporting member positioned in the atomizing outer pipe, the supporting member includes a bottom end having a disc shape, two first side walls extend upwardly from a part of edge of the bottom end, the two first side walls are symmetrically arranged about a central axis of the supporting member, two second side walls extend inwardly from a part of edge of the bottom end, and then extend upwardly, the two second side walls are symmetrically arranged about the central axis of the supporting member, each second side wall connects with the two first side walls, the first side walls and the second side walls cooperatively form the atomizing chamber, a bottom of the second side wall defines a first through hole fluidly communicating with the atomizing chamber, a separation between the second side wall and the atomizing outer pipe constitutes a first air intake chamber.

According to one embodiment, wherein a sealing member is positioned on a top of the first side wall and a top of the second side wall, an end of the sealing member is sleeved on a circumference of the ventilation pipe, an opposite end of the sealing member latches in the inner peripheries of the first side walls and the second side walls

According to one embodiment, wherein a separation between the sleeving tube and the atomizing outer pipe forms a liquid storage chamber, the side wall of the atomizing outer pipe defines an absorbing hole fluidly communicating the liquid storage chamber and the atomizing chamber, the second side wall defines a liquid inlet groove, the absorbing hole of the atomizing outer pipe fluidly communicates with the liquid inlet groove.

According to one embodiment, wherein the upper cover assembly further includes a connector member and an adjusting ring, the connector member connects the upper cover with the sleeving tube, the regulating ring is rotatably sleeved on a periphery of the connector member, the side wall of the connector member defines a liquid inlet hole fluidly communicating with the liquid storage chamber, the side wall of the adjusting ring defines an injection hole corresponding to the liquid inlet hole.

According to one embodiment, wherein the first side wall defines a second through hole located at the bottom of the liquid inlet groove, and the second through hole fluidly communicates with the second ventilation hole and the atomizing chamber.

An atomizer, includes: a sleeving tube; an atomizing head positioned in the sleeving tube, an upper cover assembly, and a base seat assembly. The atomizing head defines an atomizing chamber therein for atomizing the liquid. The upper cover assembly includes an upper cover, the side wall of the upper cover defines a first ventilation hole fluidly communicating with the atomizing chamber. The base seat assembly includes a lower cover, the side wall of the lower cover defines a second ventilation hole fluidly communicating with the atomizing chamber. Wherein, the upper cover and the lower cover are received in the sleeving tube, the side wall of the sleeving tube defines a first air intake and a second air intake. when the sleeving tube is rotated, the first ventilation hole fluidly communicates with the first air intake, and the second ventilation hole is staggered from the second air intake at the same time. Or the second ventilation hole fluidly communicates with the second air intake, and the first ventilation hole is staggered from the first air intake at the same time.

According to one embodiment, the upper cover further includes a mouth piece and a ventilation pipe. The ventilation pipe fluidly communicates the atomizing chamber with the mouth piece, the upper an upper end of the ventilation pipe extends into the mouth piece, and is rotatably connected to the mouth piece. The lower end of the upper cover is integrally provided with a connecting pipe, opposite ends of the connecting pipe are connected to the upper cover and the atomizing head respectively, a separation between the connecting pipe and the ventilation pipe constitutes a first intake passage fluidly communicating with the first ventilation hole and the atomizing chamber.

According to one embodiment, the atomizer further includes a mouth piece, wherein the mouth piece is integrally formed with the sleeving tube.

According to one embodiment, wherein the atomizing head includes an atomizing outer pipe, a heater, and an absorbing member, the heater and an absorbing member are received in the atomizing outer pipe, an inner space of the atomizing outer pipe constitutes the atomizing chamber

According to one embodiment, wherein the atomizing head further includes a supporting member positioned on a bottom of the atomizing outer pipe, a lower end of the supporting member defines a second through hole fluidly communicating with the atomizing chamber.

According to one embodiment, wherein a separation between the sleeving tube and the atomizing outer tube constitutes a liquid storage chamber, the side wall of the atomizing outer pipe defines an absorbing hole fluidly communicating with the liquid storage chamber and the atomizing chamber.

According to one embodiment, wherein the first air intake and the second air intake are staggered and located on different horizontal planes, and are located on different lines which are parallel to the axial line of the atomizing head.

According to one embodiment, wherein the first ventilation intake and the second ventilation intake are staggered and located on different horizontal planes, and are located on different lines which are parallel to the axial line of the atomizing head

An electronic cigarette includes an aforementioned atomizer.

An electronic cigarette includes an atomizer, wherein the atomizer includes an atomizing head, the atomizing head includes: a bracket forming an atomizing chamber at an inner space thereof; a second electrode assembled to an end of the bracket; and a heater received in the atomizing chamber, and an end of the heater resisting the second electrode.

In the atomizer of the present disclosure, the first air intake and the first through hole on the upper portion of the atomizer can match each other to adjust the volume of the air flow. And also, the second air intake and the second through hole on the lower portion of the atomizer can match each other to adjust the volume of the air flow. Thus, the air intake mode can be selected according to a requirement of the concentration of the smog, and then the intake air flow can be adjusted to modify the flavor and the atomizing effect.

### BRIEF DESCRIPTION OF THE DRAWINGS

The disclosure is specifically illustrated with reference to accompanying drawings and embodiments in the following description.

FIG. 1 is an isometric view of an atomizer of embodiment one of the disclosure;

FIG. 2 is an exploded view of the atomizer of embodiment one;

FIG. 3 is an exploded view of an upper cover assembly of embodiment one;

FIG. 4 is a cross-sectional view of the atomizer of FIG. 1, taken along line A-A;

FIG. 5 is a cross-sectional view of the atomizer of FIG. 1, taken along another line perpendicular to line A-A;

FIG. 6 is an isometric view of the atomizing head of embodiment one;

FIG. 7 is a cross-sectional view of an atomizer of embodiment two of the disclosure;

FIG. 8 is a cross-sectional view of the atomizer of embodiment two of the disclosure, taking along a line perpendicular to that of FIG. 7;

FIG. 9 is a cross-sectional view of an atomizer of embodiment three of the disclosure; and

FIG. 10 is a cross-sectional view of the atomizer of embodiment three of the disclosure, taking along a line perpendicular to that of FIG. 9.

Reference numerals in the drawings represent the following parts

| | | |
|---|---|---|
| Atomizer 100 | Upper cover assembly 10 | Sleeving tube 20 |
| Base seat assembly 30 | Atomizing head 40 | Mouth piece 11 |
| First regulating ring 111 | First air intake 1111, 22 | Upper cover 12 |
| Cover plate 121 | First ventilation hole 1211 | Outer ring 122 |
| Pressing plate 123 | Connector member 13 | Injection hole 131 |
| Adjusting ring 14 | Liquid inlet hole 141 | First step 142 |
| Ventilation pipe 15 | Connecting pipe 16 | First connecting member 17 |
| Second connecting member 18 | Liquid storage chamber 21 | Lower cover 31 |
| Second ventilation hole 311 | Second step 312 | Second regulating ring 32 |
| Second air intake 321, 23 | Atomizing outer pipe 41 | First air intake chamber 411 |
| Absorbing hole 412 | Heater 42 | Absorbing member 43 |
| Supporting member 44 | Atomizing chamber 441 | First through hole 443 |
| Second through hole 444 | Bottom end 445 | First side wall 446 |
| Second side wall 447 | Liquid inlet groove 448 | Sealing member 449 |
| Electrode 45 | Insulating member 46 | Sealing ring 5 |
| First intake passage 161, 1221 | | |

### DETAILED DESCRIPTION OF THE PREFERRED EMBODIMENT

Technical solutions in the embodiments of the present application will be described clearly and thoroughly hereinafter with reference to the accompanying drawings. Apparently, the embodiments described herein are merely parts of but not exclusive embodiments of the present application. All alternative embodiments obtained by those skilled in the art based on the embodiments of the present application without creative works shall fall within the protection scope of the present application.

The disclosure is specifically illustrated with reference to accompanying drawings. The accompanying drawings are schematic views showing structural features of an exemplary embodiment of the disclosure. Thus, merely the constructions related to the disclosure are shown.

### Embodiment One

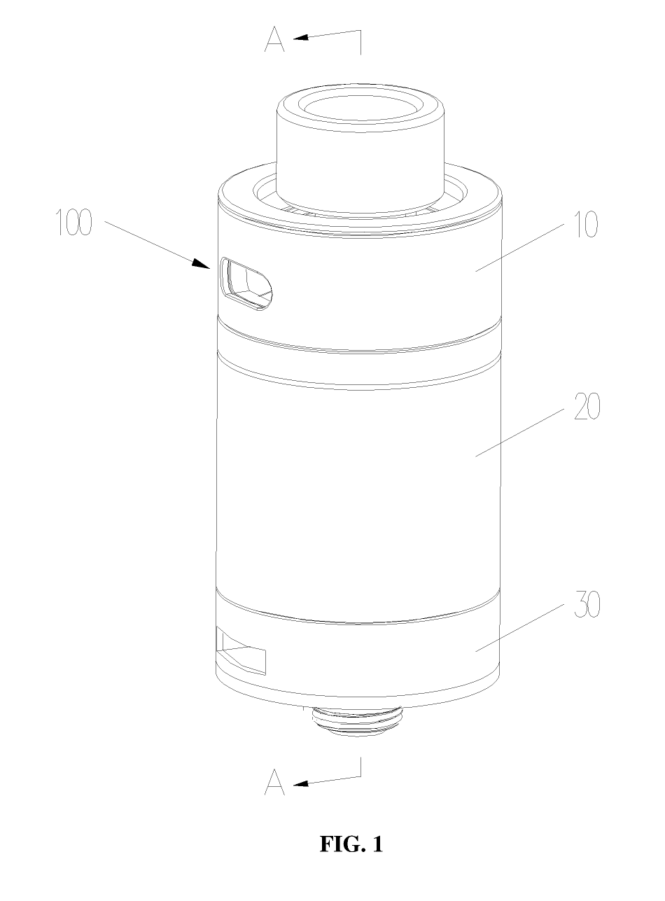

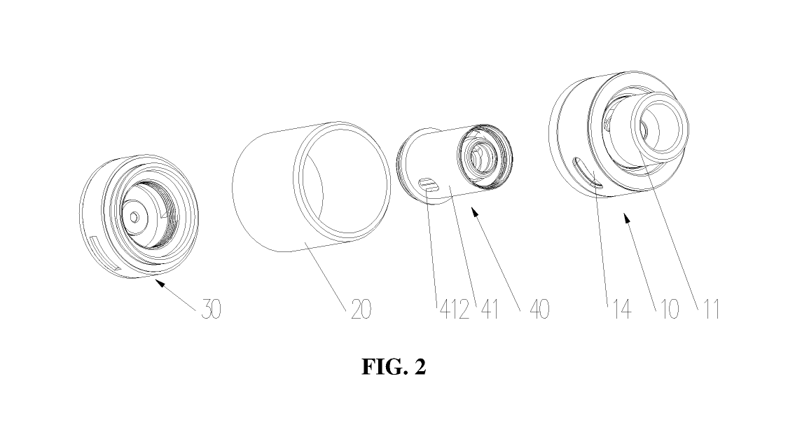

As shown in FIG. 1 and FIG. 2, the atomizer 100 provided by the illustrated embodiment includes an upper cover assembly 10, a sleeving tube 20, a base seat assembly 30, and an atomizing head 40 positioned in the sleeving tube 20. The upper cover assembly 10 is position on the upper end of the sleeving tube 20, the base seat assembly 30 is positioned on the lower end of the sleeving tube 20.

The illustrated embodiment further provides an electronic cigarette, the electronic cigarette includes an atomizer 100 and a battery pack (not shown) electronically connected to the atomizer 100. The battery pack electrically drives the atomizing head 40 to work, causing the atomizing head 40 to generate smog therein for user to swallow.

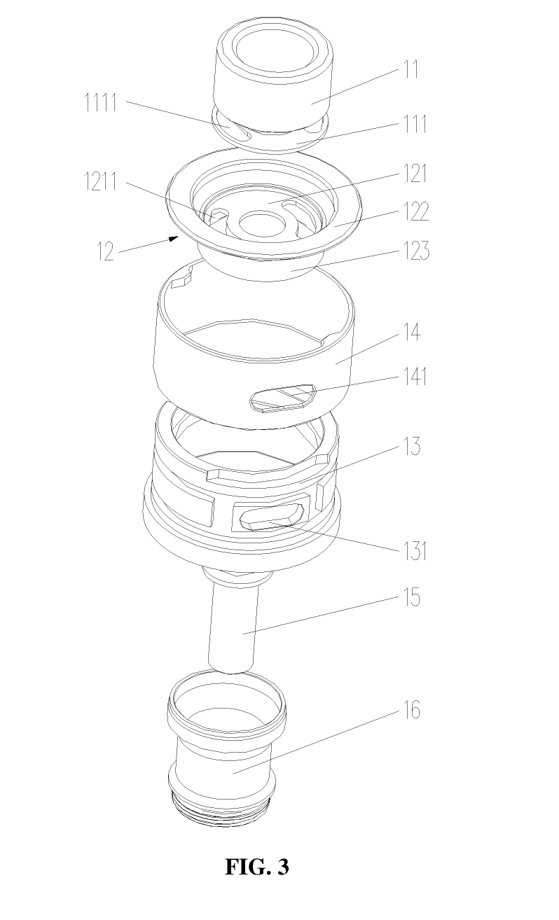

Referring to FIG. 3 through FIG. 5, the upper cover assembly 10 includes a first connecting member 17, and a second connecting member 18. At least a part of the second connecting member 18 is laminated upon the first connecting member 17. The first connecting member 17 defines a first air intake 1111, the second connecting member 18 defines a first ventilation hole 1211 fluidly communicating with the first air intake 1111. When rotating or toggling one of the first connecting member 17 and the second connecting member 18, the communication area between the first air intake 1111 and the first ventilation hole 1211 can be adjusted.

In the illustrated embodiment, the first connecting member 17 serves as a mouth piece 11, the second connecting member 18 serves an upper cover 12, the mouth piece 11 and the upper cover 12 are coaxially arranged, and latches with each other. In other alternative embodiments, the mouth piece 11 and the upper cover 12 can be detachably connected together such as by pluggable connection. In the illustrated embodiment, the upper cover assembly 10 further includes a connector member 13, a adjusting ring 14, a ventilation pipe 15 and a connecting pipe 16. The connector member 13 is rotatably sleeved on a circumference of the upper cover 12. The adjusting ring 14 is rotatably sleeved on a circumference of the connector member 13, the ventilation pipe 15 extends through a central portion of the upper cover 12. The connecting pipe 16 is sleeved on the ventilation pipe 15.

The mouth piece 11 is a hollow cylindrically structure having two openings at opposite ends of the mouth piece 11. The mouth piece 11 is integrally provided with a first regulating ring 111 at a circumference of the lower end of the mouth piece 11. The first regulating ring 111 defines the first air intake 1111. Certainly, in alternative embodiment (not shown), the mouth piece 11 can be detachably connected to the first regulating ring 111.

The upper cover 12 has a bucket shape, the upper cover 12 includes a cover plate 121 and an outer ring 122 position on a periphery of the cover plate 121. The outer ring 122 has a funnel shape. The outer ring 122 is provided with a pressing plate 123 on an upper end, the pressing plate 123 extends outwardly along a radial direction of the outer ring 122. The cover plate 121 is positioned on a central portion of the outer ring 122. The cover plate 121 defines the first ventilation hole 1211 corresponding to the first air intake 1111. The cover plate 121 and the first regulating ring 111 are laminated together. In the illustrated embodiment, the first regulating ring 111 is positioned above the cover plate 121.

In another alternative embodiment (not shown), the mouth piece 11 is formed integrally with the upper cover 12. A regulating ring is sleeved on one of the mouth piece 11 or the upper cover 12, at the time, the first connecting member 17 indicates the integral of the mouth piece 11 and the upper cover 12, the second connecting member 18 indicates the regulating ring.

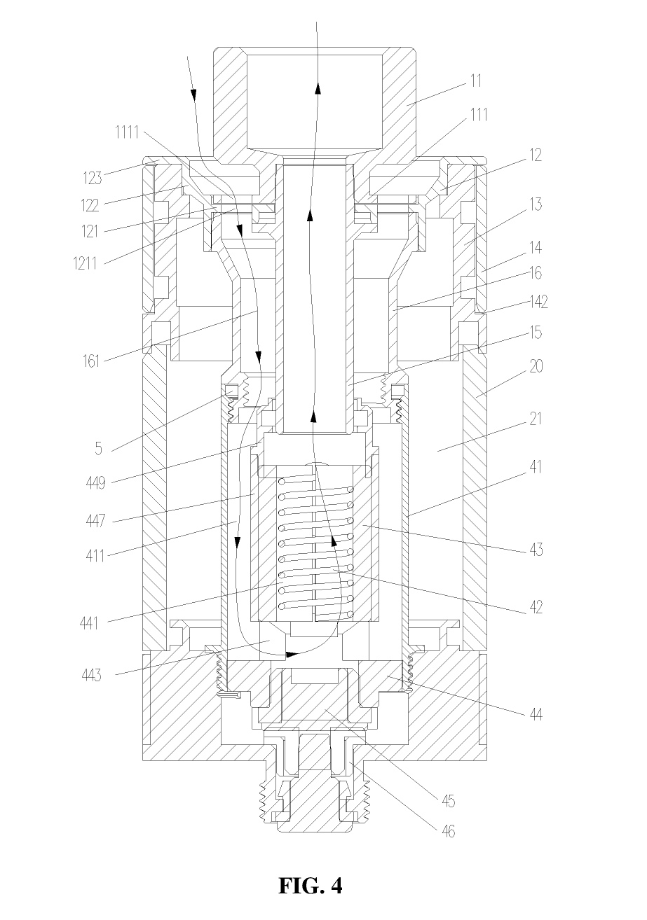

Referring to FIG. 3 and FIG. 4, in the illustrated embodiment, the connector member 13 has an annular structure, the connector member 13 has a first step 142 extending outwardly from a lower end of the connector member 13 along a radial direction of the connector member 13. The upper end of the connector member 13 is connected to a periphery of the outer ring 122 of the upper cover 12. The upper end of the connector member 13 resists the lower end surface of the pressing plate 123. The side wall of the connector member 13 defines an injection hole 131. The adjusting ring 14 is rotatably sleeved on the connector member 13. Opposite ends of the adjusting ring 14 are limited by the pressing plate 123 and the first step 142, respectively. The side wall of the adjusting ring 14 defines a liquid inlet hole 141 corresponding to the injection hole 131. When the adjusting ring 14 is rotated, the communicating state between the injection hole 131 and outside can be controlled, thus the injection hole 131 can be opened or closed.

The ventilation pipe 15 is a hollow cylindrically structure having two openings at opposite ends of the ventilation pipe 15. An end of the ventilation pipe 15 extends into the mouth piece 11 and is rotatably connected to the mouth piece 11. The ventilation pipe 15 extends through the cover plate 121 and is fixedly connected to the cover plate 121. An opposite end of the ventilation pipe 15 is connected to the atomizing head 40. The mouth piece 11 is capable of rotating relative to the cover plate 121 to adjust a communication area between the first air intake 1111 and the first ventilation hole 1211.

The connecting pipe 16 is a hollow cylindrically structure having two openings at opposite ends of the connecting pipe 16. The connecting pipe 16 is sleeved on a circumference of the ventilation pipe 15. An end of the connecting pipe 16 is fixedly connected to the lower end of the outer ring 122. An opposite end of the connecting pipe 16 is connected to the atomizing head 40. A separation between the connecting pipe 16 and the ventilation pipe 15 constitutes a first intake passage 161, which can fluidly communicate with the first air intake 1111 and the first ventilation hole 1211. By a configuration of the ventilation pipe 15 and the connecting pipe 16, the intake passage and smog vent passage are isolated, thus the air flow can flows fluently, the smoker experience is better.

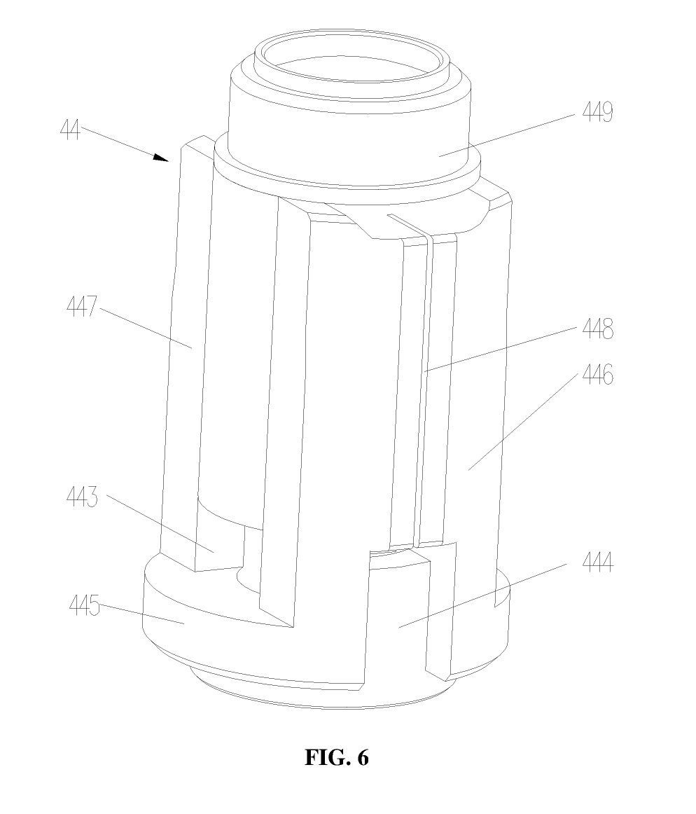

Referring to FIG. 4 through FIG. 6, the atomizing head 40 includes an atomizing outer pipe 41, a heater 42, an absorbing member 43, a supporting member 44, an electrode 45, and an insulating member 46. The heater 42 and the absorbing member 43 are received in the atomizing outer pipe 41, the supporting member 44 is received in the atomizing outer pipe 41, the electrode 45 and the insulating member 46 are assembled to the supporting member 44.

An upper end of the atomizing outer pipe 41 is connected to the lower end of the connecting pipe 16 by screws, the connecting portion is sealed by a sealing ring 5. In alternative embodiment (not shown), the atomizing outer pipe 41 can be connected to the connecting pipe 16 by latching or pressing.

The sleeving tube 20 is a hollow cylindrically structure having two openings at opposite ends of the sleeving tube 20. Opposite ends of the sleeving tube 20 are connected to the connector member 13 and a lower cover 31, respectively. A separation between the sleeving tube 20 and the atomizing outer pipe 41 forms a liquid storage chamber 21, the side wall of the atomizing outer pipe 41 defines an absorbing hole 412, the absorbing hole 412 fluidly communicates with the inner space of the atomizing head 40 and the liquid storage chamber 21. The absorbing member 43 absorbs the liquid in the liquid storage chamber 21 via the absorbing hole 412.

The supporting member 44 is assembled in the atomizing outer pipe 41, the electrode 45 extends through and assembled to a middle portion of the lower end of the supporting member 44. An end of the electrode 45 is electrically connected to the heater 42, an opposite end of the electrode 45 is electrically connected to the battery pack. The battery pack is electrically connected to the heater 42 via the electrode 45, thereby heating the heater 42 to atomize the liquid to generate smog. The insulating member 46 is sandwiched between the supporting member 44 and the electrode 45 to provide an insulating effect. In the illustrated embodiment, the insulating member 46 is made of silica gel materials. It can be understood that, in alternative embodiments (not shown), the insulating member 46 can be made of insulating materials such as rubber.

The inner space of the supporting member 44 is the atomizing chamber 441, the heater 42 and the absorbing member 43 are received in the atomizing chamber 441. In the illustrated embodiment, the heater 42 is a heat strip, the absorbing member 43 is a piece of cotton, and the heat strip is wrapped by the piece of cotton. In alternative embodiment (not shown), the heater 42 wraps the absorbing member 43.

The supporting member 44 substantially has a cylindrically shape, and includes a bottom end 445 having a disc shape. Two first side walls 446 extend upwardly from a part of edge of the bottom end 445, the two first side walls 446 are symmetrically arranged about the central axis of the supporting member 44. Two second side walls 447 extend inwardly from a part of edge of the bottom end 445, and then extend upwardly. The two second side walls 447 are symmetrically arranged about the central axis of the supporting member 44. Each second side wall 447 connects with the two first side walls 446. The first side walls 446 and the second side walls 447 cooperatively form the atomizing chamber 441. A sealing member 449 is positioned on the top of the first side walls 446 and the second side walls 447. In the illustrated embodiment, an end of the sealing member 449 is sleeved on a circumference of the ventilation pipe 15, an opposite end of the sealing member 449 lathes in the inner periphery of the first side walls 446 and the second side walls 447. In other alternative embodiments (not shown), the sealing member 449 can be connected by pressing or inserting and other connection types, merely meeting the requirement that the intake passage is isolated from the smoke vent passage. The bottom of the second side wall 447 defines a first through hole 443 fluidly communicating with the atomizing chamber 441, a separation between the second side wall 447 and the atomizing outer pipe 41 constitutes a first air intake chamber 411.

The first side wall 446 defines an liquid inlet groove 448 extending along an axial direction of the first side wall 446, when the atomizing outer pipe 41 is assembled to the supporting member 44, the bottom of the atomizing outer pipe 41 is connected to the bottom end 445 of the supporting member 44 by pressing. A part of the atomizing outer pipe 41 abuts against the first side wall 446. The absorbing hole 412 of the atomizing outer pipe 41 fluidly communicates with the liquid inlet groove 448, such that the liquid can flows through the absorbing hole 412, the liquid inlet groove 448 and then flows into the atomizing chamber 441.

The first side wall 446 defines a second through hole 444 located at the bottom of the liquid inlet groove 448, and the second through hole 444 fluidly communicates with the atomizing chamber 441. When the absorbing member 43 is assembled in the atomizing chamber 441, a separation is generated beneath the absorbing member 43 and serves for an airflow passage. The airflow passage fluidly communicates with the first through hole 443 and the second through hole 444. The bottom end 445 of the supporting member 44 defines a central through hole that contains circuit components such as electrodes and insulators.

The base seat assembly 30 includes a lower cover 31 and a second regulating ring 32. The lower cover 31 is connected to the lower end of the atomizing head 40, the second regulating ring 32 is rotatably sleeved on a circumference of the lower cover 31. The upper end of the lower cover 31 is connected to the lower end of the atomizing outer pipe 41 by screws. The lower end of the lower cover 31 is provided with a second step 312 extending outwardly along a radial direction of the lower cover 31. The second step 312 limits the position of the second regulating ring 32. The side wall of the lower cover 31 defines a second ventilation hole 311, the side wall of the second regulating ring 32 defines a second air intake 321 corresponding to the second ventilation hole 311. The second through hole 444 fluidly communicates the second ventilation hole 311 with the atomizing chamber 441. When the second regulating ring 32 is rotated, the communication area between the second through hole 444 and the second air intake 321 can be adjusted, thereby adjusting the intake air flow.

When user smokes, the mouth piece 11 can be rotated according to a requirement, to enable the first ventilation hole 1211 to fluidly communicate with the first air intake 1111, and the communication area can be adjusted. Or the second regulating ring 32 is rotated to enable the second ventilation hole 311 to fluidly communicate with the second air intake 321, and the communication area is adjusted. Meanwhile, the first ventilation hole 1211 can fluidly communicate with the first air intake 1111, and the second ventilation hole 311 can fluidly communicate with the second air intake 321 at the same time, the adjusting scope of the intake air flow can be enlarged. When the liquid in the liquid storage chamber 21 is exhausted, the adjusting ring 14 can be rotated, to enable the injection hole 131 to fluidly communicate with the liquid inlet hole 141, facilitating for adding liquid into the liquid storage chamber 21.

The arrow in FIG. 4 shows the direction of the intake air flow when the first ventilation hole 1211 fluidly communicates with the first air intake 1111. The outside air enters into the first intake passage 161 and the first air intake chamber 411 via the first air intake 1111 and the first ventilation hole 1211, and then the air flow enters the atomizing chamber 441 via the first through hole 443 and is mixed with the smog. The mixed air flows out via the ventilation pipe 15 and the mouth piece 11 successively, and is sucked into the mouth of the user.

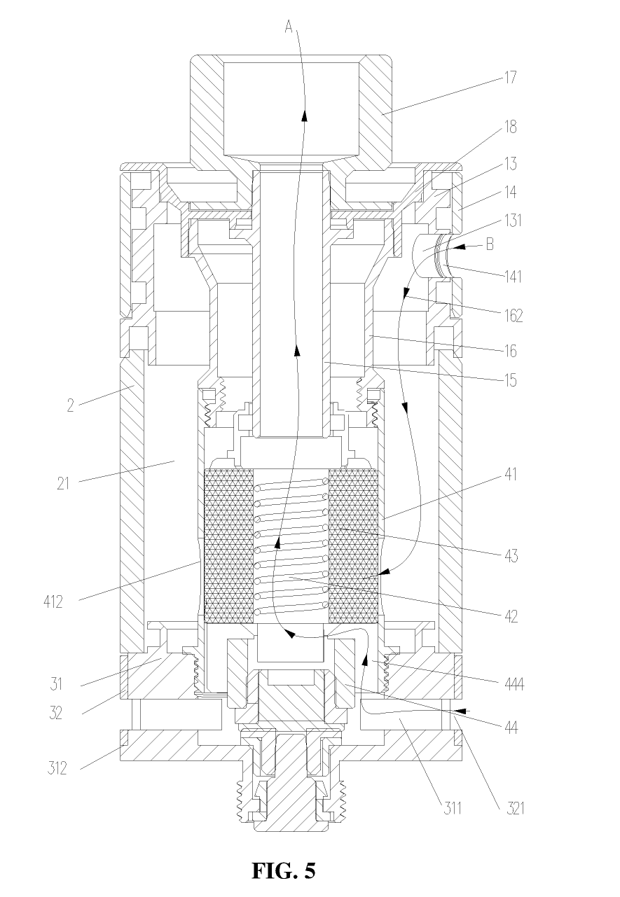

The arrow A in FIG. 5 shows the direction of the intake air flow when the second ventilation hole 311 fluidly communicates with the second air intake 321. The outside air enters into the second through hole 444 via the second air intake 321 and the second ventilation hole 311, and then the air flow enters the atomizing chamber 441 and is mixed with the smog. The mixed air flows out via the ventilation pipe 15 and the mouth piece 11 successively, and is sucked into the mouth of the user.

The arrow B in FIG. 5 shows the flow direction of the liquid when the injection hole 131 fluidly communicates with the liquid inlet hole 141 for injecting liquid. The liquid enters into the liquid storage chamber 21 via the liquid inlet hole 141 and the injection hole 131, and then the liquid is absorbed by the absorbing member 43 via the absorbing hole 412. The heater 42 is heated, and liquid absorbed by the absorbing member 43 is heated to be atomized.

In the atomizer of the present disclosure, the first air intake 1111 and the first ventilation hole 1211 on the upper portion of the atomizer can match each other to adjust the volume of the air flows. And also, the second air intake 321 and the second through hole 311 on the lower portion of the atomizer can match each other to adjust the volume of the air flows. Thus, the air intake mode can be selected according to a requirement of the concentration of the smog, and then the intake air flow can be adjusted to modify the flavor and the atomizing effect.

### Embodiment Two

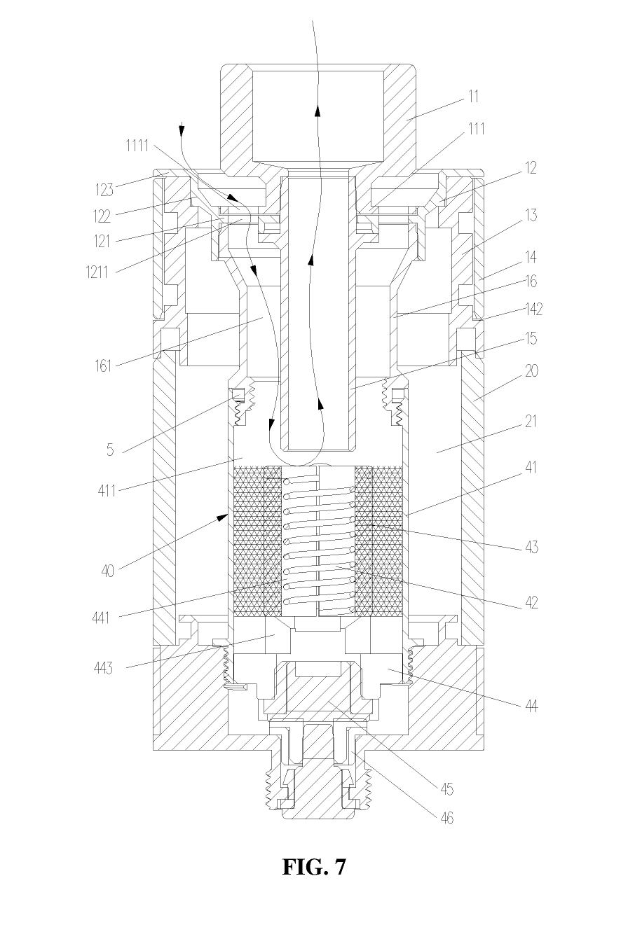

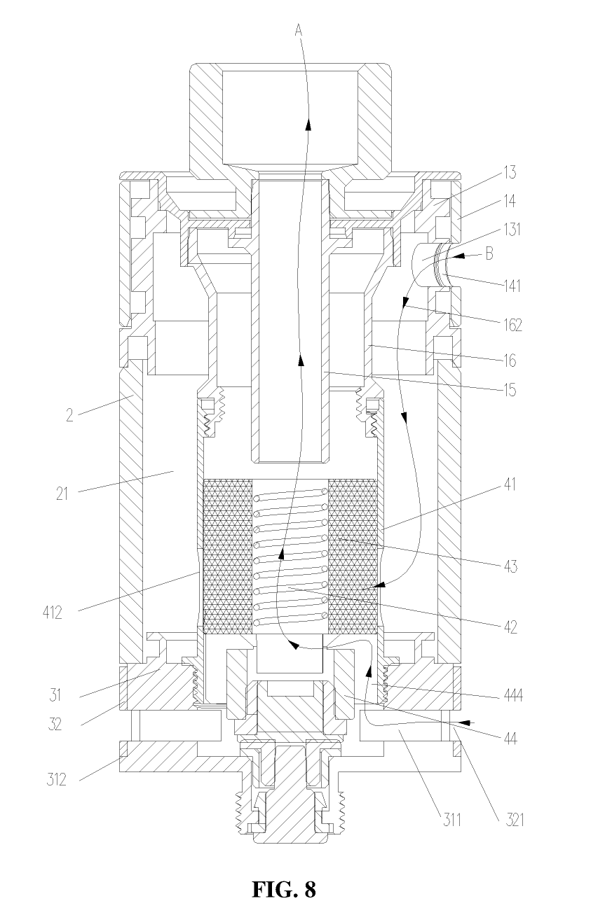

As shown in FIG. 7 and FIG. 8, the main difference between embodiment two and embodiment one is that, the supporting member 44 does not includes the first side walls 446, the second side walls 447 and the sealing member 449, and an air passing separation is formed between the heater 42 and the top of the absorbing member 43. The supporting member 44 of the illustrated embodiment substantially has a cylindrically shape, the supporting member 44 is assembled to the bottom of the atomizing outer pipe 41, the inner space of the atomizing outer pipe 41 is the atomizing chamber 441, the atomizing chamber 441 fluidly communicates with the first intake passage 161. The heater 42 and the absorbing member 43 are received in the atomizing chamber 441. The supporting member 44 defines a second through hole 444 fluidly communicating with the atomizing chamber 441.

The arrow in FIG. 7 shows the flow direction of the intake air when the first ventilation hole 1211 fluidly communicates with the first air intake 1111. The outside air enters into the first intake passage 161 via the first air intake 1111 and the first ventilation hole 1211, and then the outside air directly flows through the upper surfaces of the absorbing member 43 and the heater 42 to form a smog. The smog flows out through the ventilation pipe 15 and the mouth piece 11, and is sucked by the mouth of the user.

The arrow A in FIG. 8 shows the direction of the intake air flow when the second ventilation hole 311 fluidly communicates with the second air intake 321. In the illustrated embodiment, the direction of the intake air flow when the second ventilation hole 311 fluidly communicates with the second air intake 321 is same as that in embodiment one, and is not specifically described hereby.

The arrow B in FIG. 8 shows the flow direction of the liquid when the injection hole 131 fluidly communicates with the liquid inlet hole 141 for injecting liquid. In the illustrated embodiment, the flow direction of the liquid when the injection hole 131 fluidly communicates with the liquid inlet hole 141 is same as that of embodiment one, and is not specifically described hereby.

In the atomizer of the illustrated embodiment, the first air intake 1111 and the first ventilation hole 1211 on the upper portion of the atomizer can match each other to adjust the volume of the air flow. And also, the second air intake 321 and the second ventilation hole 311 on the lower portion of the atomizer can match each other to adjust the volume of the air flow. Thus, the air intake mode can be selected according to a requirement of the concentration of the smog, and then the intake air flow can be adjusted to modify the flavor and the atomizing effect

The illustrated embodiment further provides an electronic cigarette having aforementioned atomizer.

### Embodiment Three

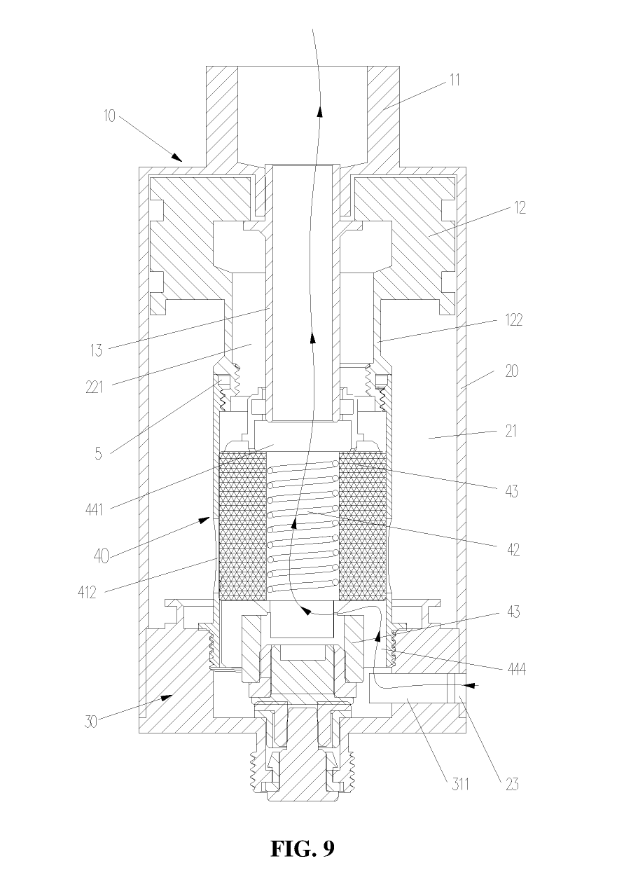

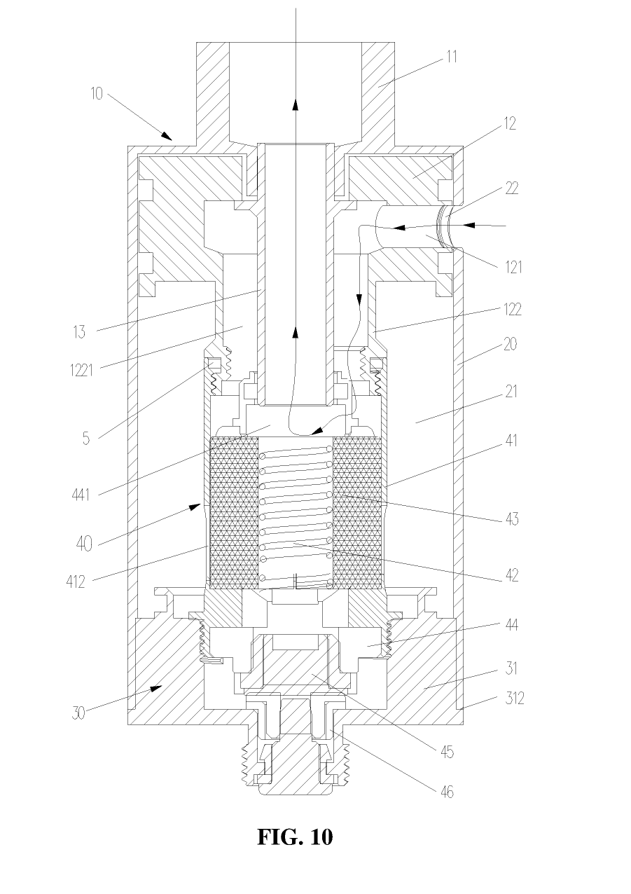

The atomizer shown in FIG. 9 and FIG. 10 includes an upper cover assembly 10, a sleeving tube 20, a base seat assembly 30, and an atomizing head 40 positioned in the sleeving tube 20. The upper cover assembly 10 is positioned on the upper end of the sleeving tube 20, the base seat assembly 30 is positioned on the lower end of the sleeving tube 20.

The upper cover assembly 10 includes a mouth piece 11, an upper cover 12 rotatably connected to the mouth piece 11, and a ventilation pipe 15.

Each of the mouth piece 11 and the ventilation pipe 15 is a tubular structure having two openings at opposite ends thereof. The lower end of the mouth piece 11 is rotatably connected to the upper end of the ventilation pipe 15. The upper cover 12 is positioned in the sleeving tube 20, the upper cover 12 is fixedly connected to the ventilation pipe 15. The side wall of the upper cover 12 defines a first ventilation hole 1211, the lower end of the upper cover 12 is integrally provided with a connecting pipe 16. A separation between the connecting pipe 16 and the ventilation pipe 15 constitutes a first intake passage 1221, and the first intake passage 1221 fluidly communicates with the first ventilation hole 1211.

The base seat assembly 30 includes a lower cover 31, the side wall of the lower cover 31 defines a second through hole 444, the lower end of the lower cover 31 forms a second step 312 extending outwardly along a radial direction of the lower cover 31.

The sleeving tube 20 is a tubular structure having two openings at opposite ends of the sleeving tube 20, the sleeving tube 20 is integrally formed with the mouth piece 11. The lower end of the sleeving tube 20 resists the second step 312. The side wall of an end of the sleeving tube 20 defines a first air intake 22 corresponding to the first ventilation hole 1211. The side wall of the opposite ends of the sleeving tube 20 defines a second air intake 23 corresponding to the second ventilation hole 311. When the mouth piece 11 or the sleeving tube 20 is rotated, the communication area between the first ventilation hole 1211 and the first air intake 22, and the communication area between the second ventilation hole 311 and the second air intake 23 can be adjusted at the same time.

The atomizing head 40 includes an atomizing outer pipe 41, a heater 42, an absorbing member 43, a supporting member 44, an electrode 45, and an insulating member 46. The heater 42 and the absorbing member 43 are received in the atomizing outer pipe 41, the supporting member 44 is assembled to the lower end of the atomizing outer pipe 41, the electrode 45 and the insulating member 46 are assembled to the supporting member 44

An upper end of the atomizing outer pipe 41 is connected to the lower end of the connecting pipe 16 by screws, the connecting portion is sealed by a sealing ring 5. In alternative embodiment (not shown), the atomizing outer pipe 41 can be connected to the connecting pipe 16 by latching or pressing. The atomizing outer pipe 41 has an inner space constituting an atomizing chamber 441, the atomizing chamber 441 fluidly communicates with the first ventilation hole 1211 via the first intake passage 1221. The atomizing chamber 441 fluidly communicates with the mouth piece 11 via the ventilation pipe 15. The heater 42 and the absorbing member 43 are received in the atomizing chamber 441. In the alternative embodiment, the heater 42 is a heat strip, the absorbing member 43 is a cotton, and the heat strip is wrapped by the cotton. In an alternative embodiment (not shown), the heater 42 wraps the absorbing member 43.

A separation between the atomizing outer pipe 41 and the sleeving tube 20 constitutes a liquid storage chamber 21. Opposite ends of the liquid storage chamber 21 are sealed by the upper cover 12 and the lower cover 31. The side wall of the atomizing outer tube 41 defines an absorbing hole 412, the absorbing hole 412 fluidly communicates the atomizing chamber 441 with the liquid storage chamber 21. In the illustrated embodiment, the atomizer is a disposable atomizer. It can be understood, in alternative embodiments (not shown), the lower cover 31 can be disassembled and a liquid injection can be performed to the liquid storage chamber 21.

The supporting member 44 is assembled to the lower end of the atomizing outer pipe 41, the side wall of the supporting member 44 defines a second through hole 444 commutating with the second ventilation hole 311 and the atomizing chamber 441. The first air intake 22 and the second air intake 23 are staggered and located on different horizontal planes, and are located on different lines which are parallel to the axial line of the atomizing head. When the sleeving tube 20 is assembled to the upper cover assembly 10 and the base seat assembly 30, and the sleeving tube 20 is rotated, the first air intake 22 and the first ventilation hole 1211, the second air intake 23 and the second ventilation hole 311 are not fluidly communicated at the same time. That is, when the first air intake 22 fluidly communicates with the first ventilation hole 1211, the second air intake 23 and the second ventilation hole 311 are closed, or when the first air intake 22 and the first ventilation hole 1211 are closed, the second air intake 23 fluidly communicates with the second ventilation hole 311. For example, the first ventilation hole 1211 and the second ventilation hole 311 are positioned on one line parallel to the axis of the atomizing head.

In alternative embodiment, the first ventilation hole 1211 and the second ventilation hole 311 are staggered and located on different horizontal planes, and are located on different lines which are parallel to the axial line of the atomizing head. When the sleeving tube 20 is assembled to the upper cover assembly 10 and the base seat assembly 30, and the sleeving tube 20 is rotated, the first air intake 22 and the first ventilation hole 1211, the second air intake 23 and the second ventilation hole 311 are not fluidly communicated at the same time. That is, when the first air intake 22 fluidly communicates with the first ventilation hole 1211, the second air intake 23 and the second ventilation hole 311 are closed, or when the first air intake 22 and the first ventilation hole 1211 are closed, the second air intake 23 fluidly communicates with the second ventilation hole 311. For example, the first air intake 22 and the second air intake 23 are positioned on one line parallel to the axis of the atomizing head.

In the illustrated embodiment, when the sleeving tube 20 is rotated, the first air intake 22 and the first ventilation hole 1211, the second ventilation hole 311 and the second air intake 23 are not closed or opened at the same time, that is, only one of the upper intake mode or the lower intake mode can be selected.

The electrode 45 is assembled to a middle portion of the supporting member 44. An end of the electrode 45 is electrically connected to the heater 42, an opposite end of the electrode 45 is electrically connected to the battery pack. The battery pack is electrically connected to the heater 42 via the electrode 45, thereby realizing a target to heat the heater 42 to atomize the liquid to form smog. The insulating member 46 is sandwiched between the supporting member 44 and the electrode 45, to provide an insulating effect. In the illustrated embodiment, the insulating member 46 is made of silica gel, it can be understood that, in the alternative embodiments (not shown), the insulating member 46 can be made of insulating materials such as a rubber.

The arrow in FIG. 9 shows the flow direction of the intake air flow when the first ventilation hole 1211 fluidly communicates with the first air intake 1111. The outside air enters into the first intake passage 1221 via the first air intake 1111 and the first ventilation hole 1211, and then the air flow directly enters the atomizing chamber 441 and is mixed with the generated smog. The mixed air flows out via the ventilation pipe 15 and the mouth piece 11 successively and is sucked into the mouth of the user.

The arrow in FIG. 10 shows the direction of the intake air flow when the second ventilation hole 311 fluidly communicates with the second air intake 23. The outside air enters into the second through hole 444 via the second air intake 23 and the second ventilation hole 311, and then the air flow enters the atomizing chamber 441 and is mixed with the generated smog. The mixed air flows out via the ventilation pipe 15 and the mouth piece 11 successively and is sucked into the mouth of the user

In the atomizer of the illustrated embodiment, the communication area between the first air intake 22 and the first through hole 443 can be adjusted, and the communication area between the second air intake 321 and the second through hole 444 can be adjusted at the same time. Thus, the air intake mode can be selected, and then the intake air flow can be adjusted to modify the flavor and the atomizing effect

The illustrated embodiment further provides an electronic cigarette having aforementioned atomizer.

The embodiments described above are merely preferred embodiments, but not intended to limit the application. Any modifications, alternatives or improvements made within the principle and spirit of the present application should be interpreted as falling within the protection scope of the present application.

What is claimed is:

1. An atomizer, comprising:
a ventilation pipe;
a connecting pipe sleeved on the ventilation pipe;
a sleeving tube;
an atomizing head positioned in the sleeving tube, the atomizing head being connected to the ventilation pipe and the connecting pipe, the atomizing head defining an atomizing chamber therein;
an upper cover assembly positioned on a top of the sleeving tube, the upper cover assembly comprising a first connecting member, and a second connecting member, at least a part of the second connecting member being laminated upon the first connecting member, the first connecting member defining a first air intake, the second connecting member defining a first ventilation hole fluidly communicating with the first air intake, a communication area between the first air intake and the first ventilation hole is capable of being adjusted; and
a base seat assembly comprising a lower cover and a second regulating ring, the lower cover being connected to the lower end of the atomizing head, the second regulating ring being rotatably sleeved on a circumference of the lower cover;
wherein the second regulating ring defines a second air intake, the lower cover defines a second ventilation hole, when the second regulating ring is rotated, the communication area between the second air intake and the second ventilation hole is adjusted, the second ventilation hole fluidly communicates with the atomizing chamber; a separation between the connecting pipe and the ventilation pipe constitutes a first intake passage communicating the first ventilation hole with the atomizing chamber.

2. The atomizer according to claim 1, wherein the first connecting member is a mouth piece, the mouth piece is integrally provided with a first regulating ring on a lower end thereof, the first air intake is defined on the first regulating ring, the second connecting member is an upper cover.

3. The atomizer according to claim 2, wherein an upper end of the ventilation pipe extends into the mouth piece, and is rotatably connected to the mouth piece.

4. The atomizer according to claim 3, wherein the atomizing head comprises an atomizing outer pipe, a heater, and an absorbing member, the heater and an absorbing member are received in the atomizing outer pipe, an inner space of the atomizing outer pipe constitutes the atomizing chamber.

5. The atomizer according to claim 4, wherein the atomizing head further comprises a supporting member positioned in the atomizing outer pipe, the supporting member comprises a bottom end having a disc shape, two first side walls extend upwardly from a part of edge of the bottom end, the two first side walls are symmetrically arranged about a central axis of the supporting member, two second side walls extend inwardly from a part of edge of the bottom end, and then extend upwardly, the two second side walls are symmetrically arranged about the central axis of the supporting member, each second side wall connects with the two first side walls, the first side walls and the second side walls cooperatively form the atomizing chamber, a bottom of the second side wall defines a first through hole fluidly communicating with the atomizing chamber, a separation between the second side wall and the atomizing outer pipe constitutes a first air intake chamber.

6. The atomizer according to claim 4, wherein a sealing member is positioned on a top of the first side wall and a top of the second side wall, an end of the sealing member is sleeved on a circumference of the ventilation pipe, an opposite end of the sealing member latches in the inner peripheries of the first side walls and the second side walls.

7. The atomizer according to claim 5, wherein a separation between the sleeving tube and the atomizing outer pipe forms a liquid storage chamber, the side wall of the atomizing outer pipe defines an absorbing hole fluidly communicating the liquid storage chamber and the atomizing chamber, the second side wall defines a liquid inlet groove, the absorbing hole of the atomizing outer pipe fluidly communicates with the liquid inlet groove.

8. The atomizer according to claim 7, wherein the upper cover assembly further comprises a connector member and an adjusting ring, the connector member connects the upper cover with the sleeving tube, the regulating ring is rotatably sleeved on a periphery of the connector member, the side wall of the connector member defines a liquid inlet hole fluidly communicating with the liquid storage chamber, the side wall of the adjusting ring defines an injection hole corresponding to the liquid inlet hole.

9. The atomizer according to claim 7, wherein the first side wall defines a second through hole located at the bottom of the liquid inlet groove, and the second through hole fluidly communicates with the second ventilation hole and the atomizing chamber.

10. An atomizer, comprising:
a sleeving tube;
an atomizing head positioned in the sleeving tube, the atomizing head defining an atomizing chamber therein for atomizing the liquid;
an upper cover assembly comprising an upper cover, the side wall of the upper cover defines a first ventilation hole fluidly communicating with the atomizing chamber; and
a base seat assembly comprising a lower cover, the side wall of the lower cover defines a second ventilation hole fluidly communicating with the atomizing chamber;
wherein the upper cover and the lower cover are received in the sleeving tube, the side wall of the sleeving tube defines a first air intake and a second air intake, when the sleeving tube is rotated, the first ventilation hole fluidly communicates with the first air intake, and the second ventilation hole is staggered from the second air intake at the same time, or the second ventilation hole fluidly communicates with the second air intake, and the first ventilation hole is staggered from the first air intake at the same time.

11. The atomizer according to claim 10, wherein the upper cover further comprises a mouth piece and a ventilation pipe, the ventilation pipe fluidly communicates the atomizing chamber with the mouth piece, the upper an upper end of the ventilation pipe extends into the mouth piece, and is rotatably connected to the mouth piece, the lower end of the upper cover is integrally provided with a connecting pipe, opposite ends of the connecting pipe are connected to the upper cover and the atomizing head respectively, a separation between the connecting pipe and the ventilation pipe constitutes a first intake passage fluidly communicating with the first ventilation hole and the atomizing chamber.

12. The atomizer according to claim 10, further comprising a mouth piece, wherein the mouth piece is integrally formed with the sleeving tube.

13. The atomizer according to claim 10, wherein the atomizing head comprises an atomizing outer pipe, a heater, and an absorbing member, the heater and an absorbing member are received in the atomizing outer pipe, an inner space of the atomizing outer pipe constitutes the atomizing chamber.

14. The atomizer according to claim 13, wherein the atomizing head further comprises a supporting member positioned on a bottom of the atomizing outer pipe, a lower end of the supporting member defines a second through hole fluidly communicating with the atomizing chamber.

15. The atomizer according to claim 13, wherein a separation between the sleeving tube and the atomizing outer tube constitutes a liquid storage chamber, the side wall of the atomizing outer pipe defines an absorbing hole fluidly communicating with the liquid storage chamber and the atomizing chamber.

16. The atomizer according to claim 10, wherein the first air intake and the second air intake are staggered and located on different horizontal planes, and are located on different lines which are parallel to the axial line of the atomizing head.

17. The atomizer according to claim 10, wherein the first ventilation intake and the second ventilation intake are staggered and located on different horizontal planes, and are located on different lines which are parallel to the axial line of the atomizing head.

18. An electronic cigarette, comprising an atomizer according to claim 1.

19. An electronic cigarette, comprising an atomizer, wherein the atomizer comprises an atomizing head, the atomizing head comprises:
a bracket forming an atomizing chamber at an inner space thereof;
a second electrode assembled to an end of the bracket; and
a heater received in the atomizing chamber, and an end of the heater resisting the second electrode.
